(19) United States
(12) Patent Application Publication
(10) Pub. No.: US 2020/0051023 A1
(43) Pub. Date: Feb. 13, 2020

(54) BUSINESS LISTING UPDATE MANAGEMENT

(71) Applicant: Yext, Inc., New York, NY (US)

(72) Inventors: Bryan Reed, Alexandria, VA (US); Kevin Caffrey, Alexandria, VA (US); Catherine Frailey, New York, NY (US); Jamie Smith, New York, NY (US); Marc Ferrentino, New York, NY (US)

(21) Appl. No.: 16/535,690

(22) Filed: Aug. 8, 2019

Related U.S. Application Data
(60) Provisional application No. 62/716,289, filed on Aug. 8, 2018.

(51) Int. Cl. G06Q 10/10

(52) U.S. Cl. CPC G06Q 10/10

(57) ABSTRACT

A system and method manage notifications associated with data of a business listing associated with a merchant system. A rule associated with a data field of the business listing is stored. The merchant system is monitored to determine an occurrence of an event corresponding to the rule. In response to the occurrence of the event, a notification is transmitted to the merchant system, the notification including a prompt to update a value stored in the data field of the business listing. A response is received from the merchant system with an updated value corresponding to the data field of the business listing. The updated value is stored and transmitted to a business listing provider system.

### CROSS REFERENCE TO RELATED APPLICATIONS

This application claims the benefit of U.S. Provisional Application No. 62/716,289, filed Aug. 8, 2018, titled “Knowledge Discovery with Knowledge Nudge for Enhanced Business Listings,” the entirety of which is hereby incorporated by reference herein.

### TECHNICAL FIELD

The disclosure relates generally to natural language processing, search engines and knowledge discovery, and more particularly, to a knowledge search engine platform for enhanced business listings.

### BACKGROUND

A merchant maintains an online presence via business listings made available in response to end-user searches executed via multiple different search providers (e.g., search engines) or the merchant's own website. However, the data included in the merchant's business listing is frequently incomplete, out-of-date, inconsistent, or inaccurate. Furthermore, the merchant may be unaware of issues concerning the quality of the data of their own business listings. The propagation of business listing data that is stale, incorrect, or incomplete leads to end-user customer frustration, unhappiness, and the potential loss of business opportunities.

### BRIEF DESCRIPTION OF THE DRAWINGS

The present disclosure is illustrated by way of example, and not by way of limitation, and can be more fully understood with reference to the following detailed description when considered in connection with the figures as described below.

FIG. 1 illustrates an example of a computing environment including a knowledge management system for managing notifications relating to business listing data of a merchant system, in accordance with one or more aspects of the disclosure.

FIG. 2 illustrates is a process flow diagram of an example method to manage notifications relating to business listing data of a merchant system, in accordance with one or more aspects of the disclosure.

FIG. 3 illustrates is a process flow diagram of an example method to manage notifications relating to business listing data of a merchant system, in accordance with one or more aspects of the disclosure.

FIG. 4 illustrates is a process flow diagram of an example method to manage notifications relating to business listing data of a merchant system, in accordance with one or more aspects of the disclosure.

FIG. 5 illustrates an example interface accessible by a merchant system to manage aspects of a notification management component, in accordance with one or more aspects of the disclosure.

FIG. 6 illustrate example exchanges including notifications generated and transmitted by a notification management component in according with a notification rule, in accordance with one or more aspects of the disclosure.

FIG. 7 illustrates an example interface associated with management of notifications relating to data fields of a business listing data associated with a merchant system, in accordance with one or more aspects of the disclosure.

FIG. 8 illustrates an example computer system operating in accordance with some embodiments of the disclosure.

### DETAILED DESCRIPTION

Many businesses are increasingly concerned about their online impressions, in particular, the accuracy of the information relating to their business as provided in response to end user searches. Because there are many different providers presenting business listings relating to a merchant, maintaining accurate, updated, and consistent information can be a challenge. For example, an end user (e.g., a potential customer) may conduct a web-based search for information relating to a business using a first search provider system and receive information that is different than the business listing for that same merchant as provided by a second search provider. The merchant may not be aware of the proliferation of inaccurate, outdated (i.e., stale), or inconsistent information in their business listings. In such cases, significant business opportunities can be lost or frustrated if an end user is unable to quickly and efficiently identify updated and accurate business listing information via the end user's preferred search provider system. Conventional systems fail to provide merchants with a mechanism to monitor the data presented in their respective business listings to ensure updated, complete, and accurate business listings across multiple different search providers.

Aspects of the present disclosure address the above and other deficiencies by a knowledge management system and method to establish one or more rules (also referred to as “notification rules”) governing the dissemination of a notification to a merchant system relating to the updating one or more data fields associated with a business listing of the merchant. In an embodiment, the notification includes a message or communication (also referred to as a “nudge”) that provides the merchant system with a prompt to provide information associated with a business listing. In an embodiment, the rule can define criteria relating to the dissemination of the notification to prompt the merchant system for a business listing update. The business listing update can include the completion of one or more data fields of the business listing, the correction of a value of one or more data fields of the business listing, the changing of a value of one or more fields of the business listing.

According to embodiments, the criteria of the rule can include an indication of one or more data fields (or data field types) and/or a notification frequency, timeframe, or schedule (e.g., daily, weekly, monthly, quarterly, yearly, etc.). In an embodiment, a knowledge management system according to the present disclosure can monitor activities associated with the business listing of a merchant system and determine that a data field identified by the notification rule has not been updated within an frequency identified by the notification rule (e.g., determine that there have been no updates to a first data field in the last week, where the notification rule sets a frequency or timeframe of one week). In an embodiment, in response to this determination, the knowledge management system transmits a notification or nudge to the corresponding merchant system. The notification provides the merchant system with a prompt relating to the updating of the identified data field. The notification can provide the basis for the merchant system to respond with information that can be processed by the system to execute an updating of the identified data field. According to embodiments, the notification rule can be established by the knowledge management system in view of one or more selections provided by the merchant system, analytics based on historical data associated with the merchant system, end-user search query activity, or any combination thereof.

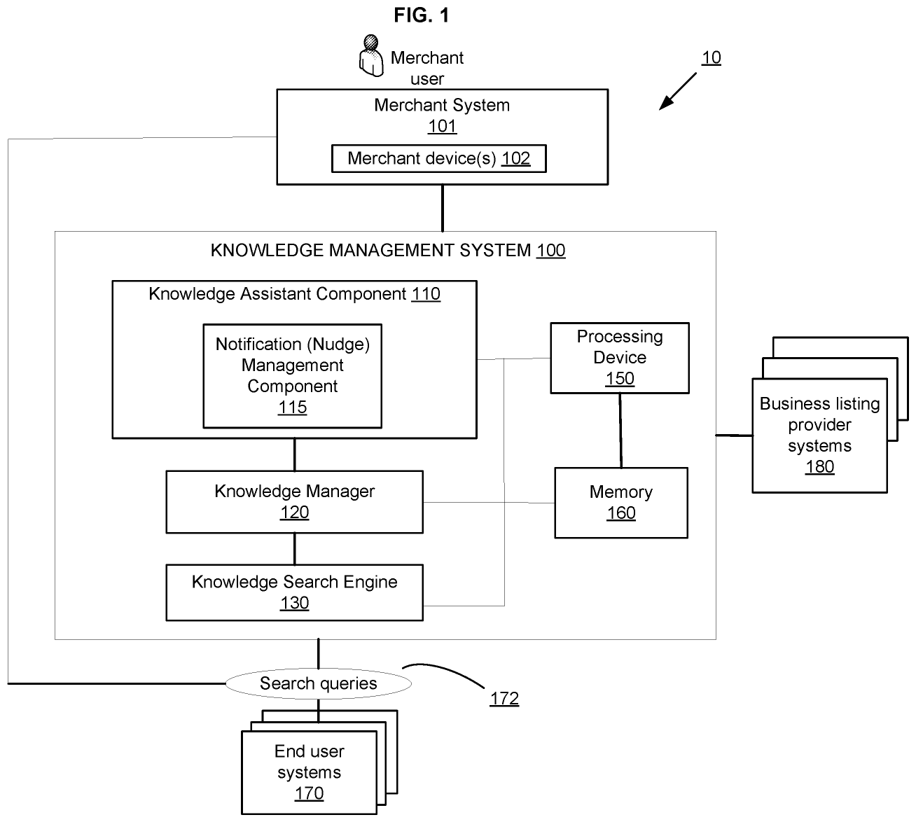

FIG. 1 illustrates an example environment 10 including a knowledge management system 100 operatively coupled via one or more networks (not shown) to one or more merchant systems 101, merchant devices 102, end user systems 170, and one or more business listing provider systems 180, in accordance with implementations of the disclosure. In one embodiment, the network may be any suitable network, including, for example, the Internet, intranets, extranets, wide area networks (WANs), local area networks (LANs), wired networks, wireless networks, or other suitable networks, etc., or any combination of two or more such networks.

In an embodiment, the knowledge management system 100 is configured to execute operations, processes, and functionality to manage data included in one or more business listings on behalf of a merchant system 101. According to embodiments, the knowledge management system 100 may include one or software modules, such as knowledge assistance component 110, a notification management component 115 (also referred to as a nudge management component), a knowledge manager 120, and a knowledge search engine 130 operatively coupled to a processing device 150 and a memory 160. In one embodiment, the software modules may be executed on one or more computer platforms of the knowledge management system 100 that are interconnected by one or more networks. The knowledge management system 100 can include one or more hardware component, circuitry, dedicated logic, programmable logic, microcode, etc., that may be implemented in the processing device 150 configured to execute instructions stored in the memory 160 to perform the functionality and operations described herein.

As used herein, the term “business listing” refers to any data or information relating to a merchant, including information about the merchant's goods, services, locations, hours of operation etc. For example, the business listing can include any information about the merchant that may be searched for by an end user and provided by a business listing provider system 180 as a response to a search query.

As used herein, the term “end user” refers to one or more users operating an electronic device (e.g., end user system 170) to submit a search or input query 172 associated with a merchant (e.g., for business listing data associated with the merchant). For example, the end user may be a customer or prospective customer searching for information about one or more merchants. The knowledge management system 100 may be operatively coupled to the end user systems 170 to identify one or more search queries provided by one or more end users relating to business listings associated with the merchant system 101. For example, the user device 130 may be associated with an end user that may be a customer or potential customer of a merchant seeking information about the merchant or a related product/service (e.g., business listing data). The end user may be searching for information via the merchant system 101 (e.g., a merchant website) or via one or more of the business listing provider systems 180, as described in greater detail below.

In an embodiment, the knowledge management system 100 includes the knowledge assistant component 110 configured to manage communications with the one or more merchant systems 101. The knowledge assistant component 110 is a communications platform that allows merchant systems 101 (e.g., merchant users using merchant device 102) to interact with the knowledge management system 100 to perform various operations, such as, for example, managing and maintaining business listings data (e.g., a merchant's holiday hours, updated menu information, regular business hours, contact information, product information, services information, etc.). In an embodiment, the knowledge assistant component 110 includes a notification management component 115 (also referred to as a “nudge management component 115”).

According to embodiments, the knowledge manager 120 is configured to operatively couple to the merchant system 101 to manage the data associated with the merchant system 101 and the associated business listings. In an embodiment, the knowledge manager 120 maintains a data store (e.g., a database) to store the information related to the merchant system 101 (e.g., product brand data, location information, etc.) In an embodiment, the knowledge manager 120 includes an interface to enable communications with the merchant system 101 to manage the information associated with the merchant system 101 (also referred to as the business listing data). According to embodiments, the knowledge manager 120 operatively couples with the knowledge assistant component 110 and notification management component 115 to enable communications with the merchant system 101 to assist the merchant system 101 in managing their business listing data.

According to embodiments, the knowledge assistant component 110 allows merchant users and end users to communicate with the knowledge management system 100 across various technologies and platforms. The knowledge assistant component 110 is a communications platform that allows merchant systems 101 (e.g., merchant users) to interact with the knowledge management system 10 to perform various operations, such as, for example, provisioning or updating content associated with the merchant (e.g., identifying the merchant's holiday hours, updated menu information, regular business hours, contact information, etc.), receiving requests to change profile content (e.g., add a photo to the photo gallery), or notifying merchant users of publisher data suggestions and allowing merchant users to accept or reject the suggestions (e.g., a proposed change to the merchant information). In some embodiments, the merchant users may use a dialog interface on a merchant device 102 (e.g., a mobile phone) to directly send updated information to the knowledge management system 100. In some embodiments, the dialog interface may include, but is not limited to SMS, phone, and instant message. In some embodiments, the merchant user may interact with a dialog interface generated by an application installed on the merchant system 101 and merchant device 102 or a web service accessible via a web browser of the merchant system 101 and the merchant device 102. In embodiments, the processing logic of the knowledge management system 100 updates the business listing data in an associated database and then automatically transmits or pushes the business listing data to the business listing provider systems 180 and/or the merchant system 101. In some embodiments, the data (e.g., updated data) provided by the merchant system may be matched to one or more listings or profiles associated with the merchant system 101 (e.g., a listing maintained by the knowledge management system 100 or one or more of the business listing provider systems 180) to enable the locking or setting of the updated information in the one or more associated business listings. For example, the data may be matched and set in a corresponding listing according to suitable techniques, such as those described in greater detail in U.S. Pat. No. 8,819,062, which is incorporated herein by reference in its entirety.

In an embodiment, an end user may use an end user system 170 (e.g., a mobile device, a desktop computing device, a laptop computing device, etc.) to submit a suggested or requested change or edit to a portion of the business listing data (e.g., the end user may suggest a change to the operating hours of the merchant if the end user determines that the published hours are incorrect). In response, the knowledge assistant component 110 may review the proposed or suggested change and provide the change request to the merchant system. In one embodiment, the knowledge assistant component 110 may update information associated with a merchant and provide a notification of the update or change to the merchant system 101.

In an embodiment, in response to the knowledge assistant component 110 registering a location with a merchant with and confirming that the merchant user has a validated phone or social media account linked (depending on the interaction type), the knowledge management system 100 may engage with the merchant user on the associated social network platform. As a result, merchant user can update information via a user device by communicating with knowledge assistant component 110.

According to embodiments of the present disclosure, the knowledge assistant component 110 executes searches based on input from the merchant user (e.g., input queries submitted via merchant system 101). In one embodiment, the search may be conducted based on information inputted by the merchant user (e.g., their zip code, geolocation or other information that could lead to the determination of the merchant user's location and/or location of interest). In another embodiment the search may be based on where the merchant system 101 is searching from (for example, the merchant system's IP address is queried and used in connection with the search). In an embodiment, the knowledge assistant component 110 receives and processes search queries 172 from one or more end user systems 170. The search queries 172 can be used by the notification management component 115 of the knowledge assistant component 110, as described in greater detail below.

According to embodiments, the knowledge assistant component 110 includes a notification management component 115 to manage and provide notifications to the merchant system 101 relating to the updating of associated business listing data. The notification management component 115 enables merchant systems 101 to establish, create, generate, or employ one or more notification rules to define criteria governing communications by and between the knowledge management system 100 relating to management of a business listing. In an embodiment, the notification rules and identified criteria are used by the notification management component 115 to determine the timing (e.g., a transmission date/time and a frequency for follow-up communications, if any) for when to generate and transmit a communication to the merchant system 130 relating to updating one or more data fields of a business listing. In an embodiment, the notification rules and identified criteria are used by the notification management component 115 to identify one or more data fields of a business listing to target as part of the notification. The notifications serve as “nudges” (e.g., suggestions or reminders) for the merchant system 101 to provide an update (e.g., new data, a correction of data, a change of data, etc.) of one or more data fields of the business listing.

According to embodiments, the notification generated by the notification management component 115 can be transmitted to the merchant system 101 via any suitable communication platform (e.g., Facebook™ messenger, e-mail, chat program, browser-based communication, etc.) and in accordance with any suitable communication protocol (e.g., SMS, HTML, etc.). In an embodiment, one or more merchant devices 102 (e.g., a mobile device associated with an administrator or manager identified by the merchant). Advantageously, merchant systems 101 having multiple locations (e.g., a restaurant chain) that conventionally have difficulty keeping business listing data updated (e.g., current, complete, and accurate), can use the notification management component 115 to establish notification rules to execute notifications relating to the updating of the business listing data. For example, department Store X may have 100 locations, and each of those locations have managers that can help set store hours, business phone numbers, etc. In response to a notification from the notification system, the merchant system 101 associated with department Store X can update the business listing data (e.g., store hours, phone number, etc.) for one or more of the individual stores to enable the knowledge manager 120 to disseminate the updated data to the network of business listing provider systems 180. If the data is wrong on a publisher site, for example Yelp, that may cause the company's customers to find wrong information, which may lead to a bad customer experience.

In some embodiments, a merchant user at a company corporate office can use an interface (e.g., an interface to the knowledge assistant component 110) to select, enter, or provide parameters to configure the notifications or nudges managed by the notification management component 115. In an embodiment, specific data fields of the business listing data can be selected or management by the notification management component 115. In addition, a desired timeframe (e.g., periods of time) or frequency of the notifications can be selected by the merchant system 101 for management of the notifications by the notification management component 115. For example, an administrator associated with the merchant system 101 (Admin User A) can set the notification rules to have notification management component 115 initiate one or more notifications to one or more specific store managers every six months (e.g., the frequency to confirm that the business listing data maintained by the knowledge manager 120 is accurate). In response to the notification, a store manager can send a communication (e.g., an SMS message) with updated information to enable the notification management component 115 to update that information maintained by the knowledge manager 120. In some embodiments that information can be automatically pushed to one or more business listing provider systems 180.

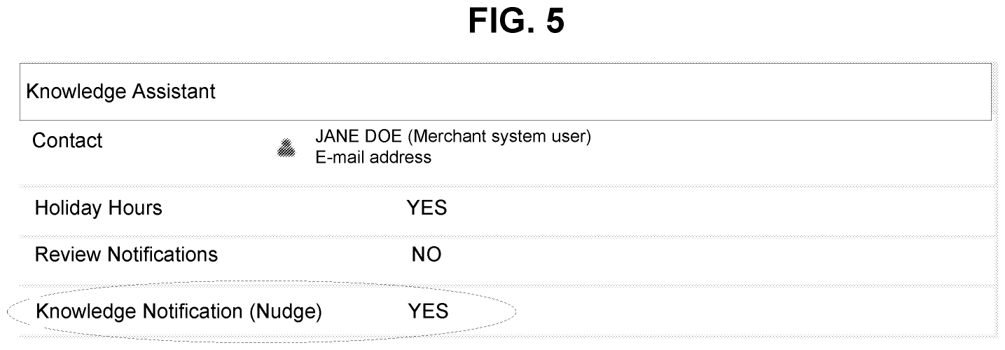

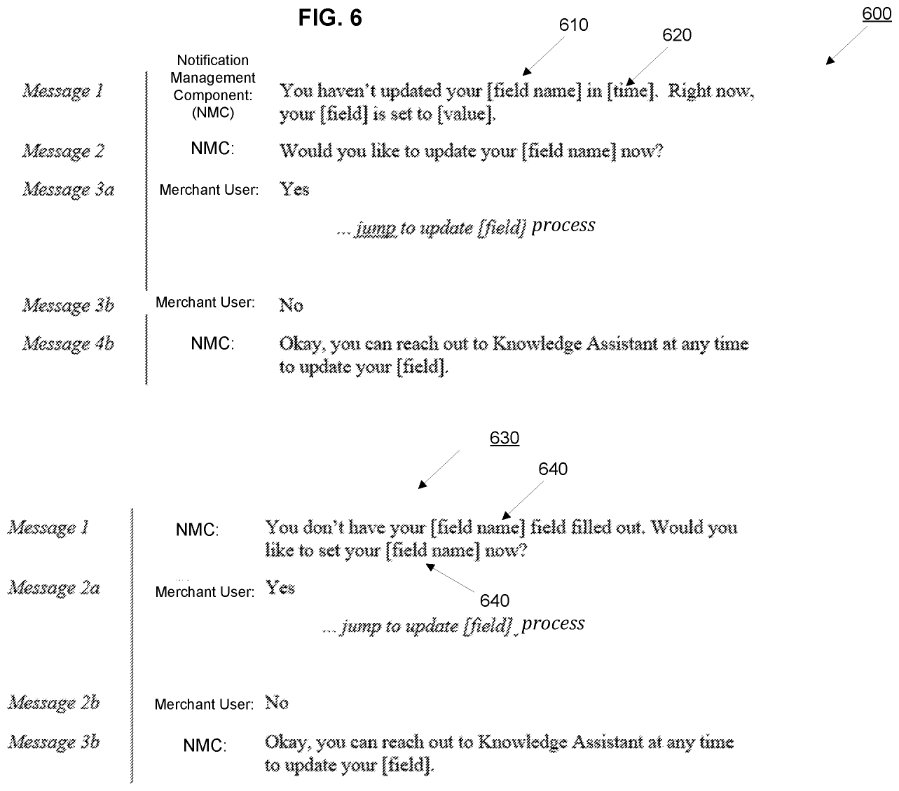

According to embodiments, the notifications or messages are generated and transmitted by the notification management component 115 to prompt or “nudge” the merchant system 101 to update the business listing data (e.g., review, change, augment, confirm). In certain embodiments, as shown in FIG. 5, a merchant system 101 can access features associated with the notification management component 115 via an account settings portal of the knowledge assistant component 110, such that the merchant user can opt-in to the notification features. FIG. 6 illustrates example notifications or nudges that can be sent by the notification management component 115 and corresponding exchanges (including responses) with the merchant system 101. The notifications (e.g., Message 1 in example exchanges 600 and 630) can relate to a target or designated data field 610 and identify a frequency 620 (e.g., a time since a last update to the identified data field or data field type 610). For example, the exchange 600 represents an example of a notification transmitted according to a notification rule identifying a particular data field and frequency. In another example, the exchange 630 represents an example of an on-demand (or one-time) notification (e.g., initiated by the merchant system 101 or the notification management component 115).

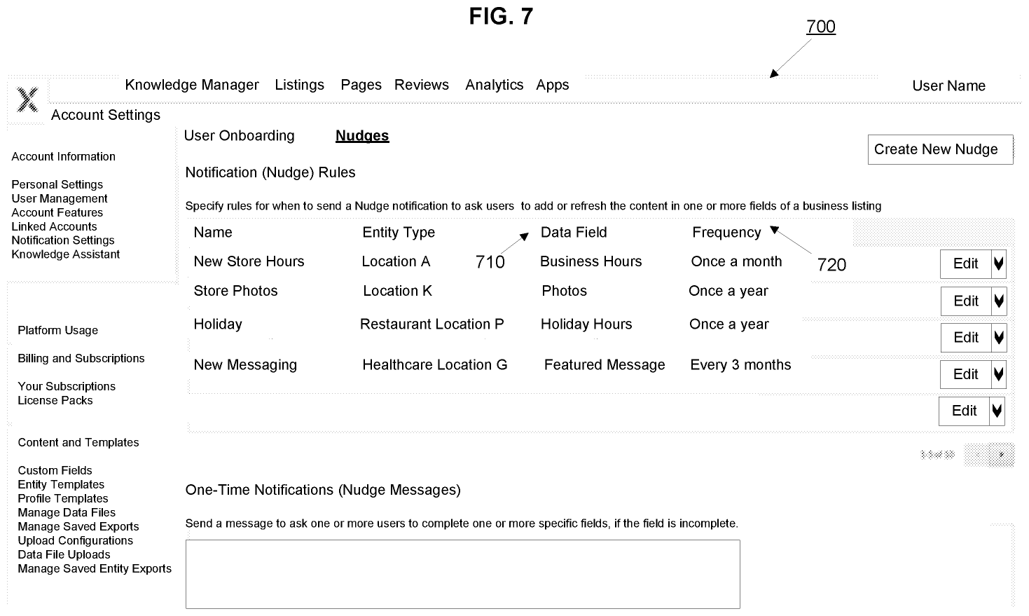

As shown in FIG. 7, the merchant user can select one or more data fields or data field types 710 from the list of eligible can fields and can opt to send a notification or nudge on an on-demand or scheduled basis (e.g., at a selected frequency 720), as shown in the example interface 700. The notification can be sent to one or more designated merchant users (e.g., to merchant devices 102 associated with the identified merchant users).

According to embodiments, the notification management component 115 manages the notification rules including criteria defining the content of the notifications (e.g., the one or more data fields that are targeted) and the time of the notifications (e.g., when and how often the messages are sent to the merchant system). In an embodiment, the notification management component 115 monitors one or more entities associated with the merchant system 101, and upon determining a specified data field has not been updated for the specified time, a notification is generated and transmitted to the merchant system 101. For example, a merchant user may choose “Description” and time frame of “six months”, so any “Description” data field of a business listing that has not been updated in six months would be considered stale. At any point that a data field is considered “stale”, the notification management component 115 prompts the entity's contact to confirm or update the data field's value. In other embodiments, a notification may be sent during a particular time frame even if the particular data field (e.g., “Description”) is updated at some point during the time frame.

In some embodiments, notification rules may be created automatically instead of added by users. For example, the notification management component 115 may track how often a particular merchant updates its information and/or how often a particular industry updates specific information via analytics processing. If a particular merchant updates its business hours every four months, on average, a notification rule can be generated (and/or recommended to a merchant user) to notify users every four months and confirm whether the information is updated. In some embodiments, the message may be sent by the notification management component 115 if the data field value was not updated within the four-month period. In some embodiments, the notification management component 115 may select the user to notify based on certain criteria (e.g., the user associated with a particular store, a user associated with a store that did not update its information for a certain period of time).

In other embodiments, the notification rules may be created or suggested to users based on one or more search queries 172 submitted by one or more end user systems 170 to the knowledge search engine 130 (or via the merchant system 101). For example, a customer of Company A may carry out a search on Company A's website (i.e., the merchant system 101). For example, a customer may have previously searched for business hours of an insurance agent and found out the data was incorrect. If the customer searches for correct hours for insurance agent, the inquiry may be sent, via the knowledge search engine 130 to the knowledge manager 120 as analytics. The inquiry may be used, via the notification management component 115 to create a notification. In this example, the notification may be a message to Company A asking them to confirm hours of the particular insurance agent (e.g., confirm the current value of the “hours” data field), either as a one-time notification or in accordance with selected timing parameters (e.g., a frequency and/or time frame).

In other embodiments, the knowledge manager 120 may track a performance of particular users (e.g., updating activity) and send notifications via the notification management component 115 to particular users based on the user performance data. For example, Company A may have Corporate User A, Location User A, Location User B, and Location User C. The notification management component 115 can track how frequently Location Users update the information for their particular locations. If Location User A and Location User B consistently update their information, but Location User C has not updated their information in five months, then the notification management component 115 may send a notification only to Location User C or create a notification rule (or recommend a notification rule) to Corporate User A (who manages the company account as a whole) for sending notifications to Location User C every five months asking if the information is up to date.

In other embodiments, a non-administrative user of the knowledge manager 120 (e.g., a store location manager) can update the notification rules via the notification management component 115, instead of relying on an “Admin User” (e.g., send a text message asking the notification to be sent every six months instead of every five months). In other embodiments, a user can request, based on account privileges, a change to notification rules via the notification management component 115. A message may be sent to a user that can change the notification rules via the notification management component 115 (e.g., an “Admin User”). Such user can confirm in a message via the notification management component 115 whether the notification rules should be updated or not.

In other embodiments, the notification management component 115 may be integrated as a program or application into a website or social media account associated with the merchant system 101. In this embodiment, end user customers of the merchant may use the widget to send a message to the merchant via the notification management component 115 to update the merchant business listing data.

In other embodiments, the notification management component 115 may determine if information is incorrect and send a message to a merchant user to update the information (e.g., a notification indicating that 99 out of 100 locations of the merchant have a first value for a particular data field, but the other location has a different value).

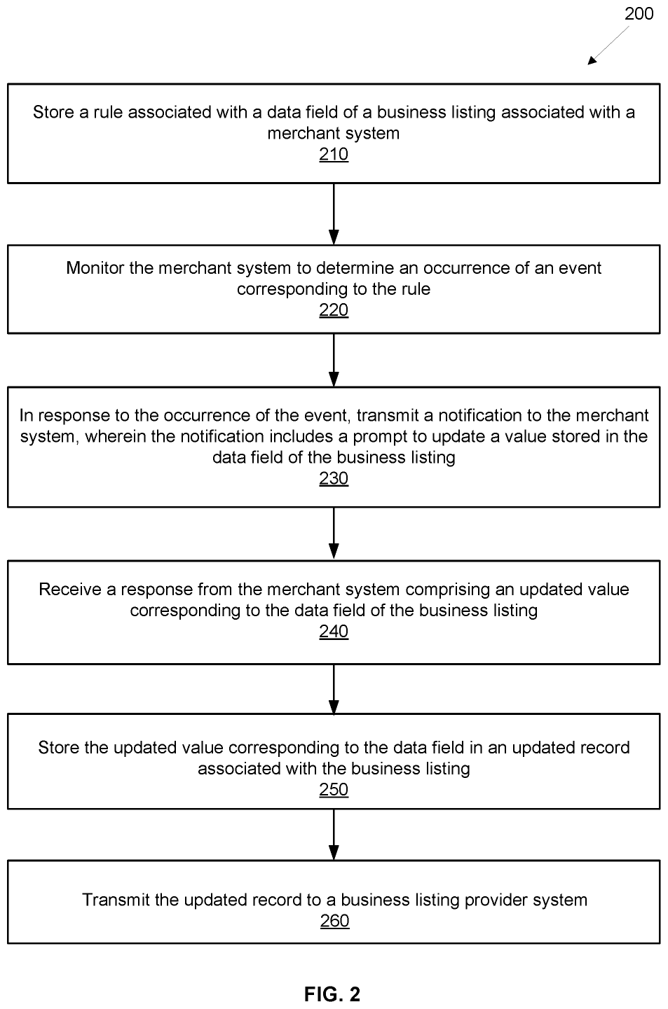

FIG. 2 illustrates a flowchart that provides an example of a process 200 executed by processing logic of a system (e.g., a notification management component 115 of a knowledge management system 100 of FIG. 1), according to various embodiments. It is understood that the flowchart of FIG. 2 provides an example of the many different types of functional arrangements that may be employed to implement the operation of the notification management component as described herein. Process 200 may be performed by a processing logic that may comprise hardware (e.g., circuitry, dedicated logic, programmable logic, microcode, etc.), software (e.g., instructions run on a processing device), or a combination thereof. In one embodiment, the notification management component executes the method 200 to process notifications in accordance with a notification rule associated with one or more data fields of a business listing associated with a merchant system.

According to embodiments, at operation 210, the processing logic stores a rule associated with a data field of a business listing associated with a merchant system. In an embodiment, the rule (or notification rule) identifies a time parameter associated with transmission of a notification to the merchant system to update the one or more data fields of the business listing data. In an embodiment, the time parameter can identify a time (e.g., date or day and time of day) to transmit the notification. In an embodiment, the time parameter identifies a time frame (e.g., a duration of time) within which the notification and one or more associated follow-up notifications are to be transmitted. In an embodiment, the time parameter identifies a frequency (e.g., hourly, daily, weekly, monthly, quarterly, yearly, etc.). In an embodiment, the rule and associated criteria (e.g., the data field, time parameter, point of contact, etc.) can be selected by a merchant user via the merchant system or generated by the notification management system.

According to embodiments, at operation 220, the processing logic monitors the merchant system to determine an occurrence of an event corresponding to the rule. In an embodiment, the event can include one or more of a satisfaction of the time parameter (e.g., a passage of the designated time frame without an update to the identified data field). In an example, the processing logic can monitor the merchant system to determine the identified data field has not been updated during the time frame set in the rule). In an embodiment, the event can include the expiration of the time parameter (e.g., the time frame or time period) associated with the rule.

According to embodiments, at operation 230, in response to the occurrence of the event, the processing logic transmits a notification to the merchant system, wherein the notification includes a prompt to update a value stored in the data field of the business listing. In an embodiment, the update can include adding, changing, correcting, deleting, or amending the value of the data field (e.g., an address, store hours, contact information, etc.). In an embodiment, the notification can be transmitted to the merchant system via any suitable communications platform or protocol (e.g., SMS message, e-mail, post, chat, etc.). Examples of a notification and corresponding exchange (e.g., notification and exchange 600 and 630) with merchant system are shown in FIG. 6.

According to embodiments, at operation 240, the processing logic receives a response from the merchant system including an updated value corresponding to the data field of the business listing. In an embodiment, in response to the notification, the merchant system (e.g., a designated point of contact at the merchant) can provide the updated value including a new value for the data field or change a current value of the data field. In some embodiments, the response can be transmitted to the knowledge management system 100 via any suitable communications platform or protocol (e.g., SMS message, e-mail, post, chat, etc.).

According to embodiments, at operation 250, the processing logic stores the updated value corresponding the data field in an updated record associated with the business listing. The processing logic can maintain a data store (e.g., a database) including records corresponding to business listing data of multiple different merchants and multiple different entities of a merchant (e.g., store locations of a merchant). An updated record can be generated upon receipt of one or more updated values of the data fields of the record.

According to embodiments, at operation 260, the processing logic transmits the updated record to a business listing provider. In an embodiment, the updated record can be sent to multiple different business listing providers (e.g., the merchant system's website, a search provider (e.g., Google™), a third party website or application (e.g., Yelp™).

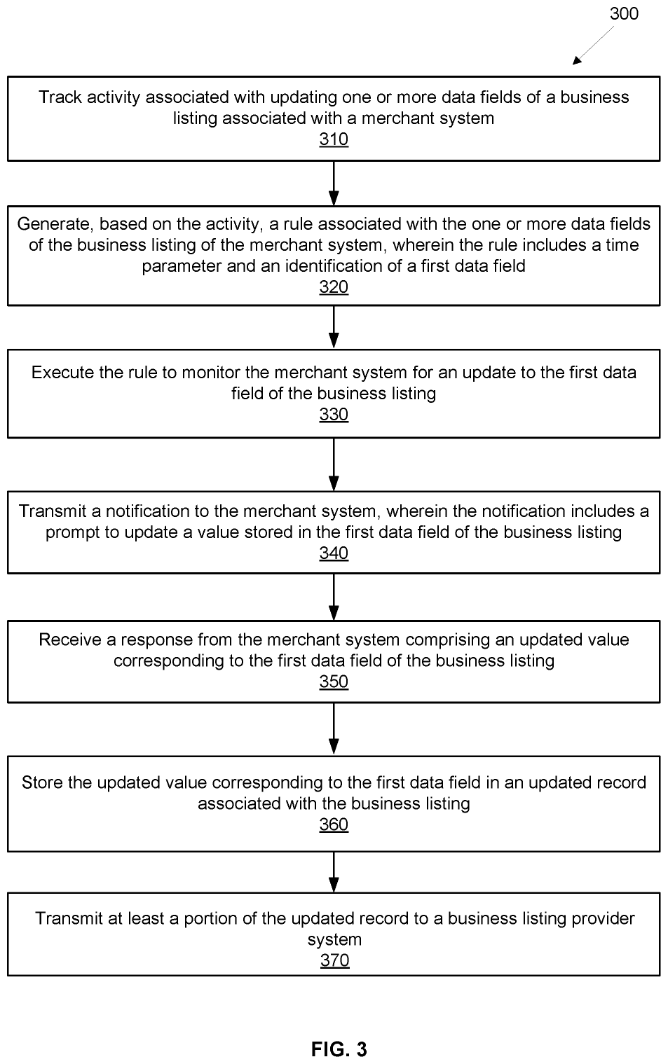

FIG. 3 illustrates a flowchart that provides an example of a process 300 executed by processing logic of a system (e.g., a notification management component 115 of a knowledge management system 100 of FIG. 1, according to various embodiments. It is understood that the flowchart of FIG. 3 provides an example of the many different types of functional arrangements that may be employed to implement the operation of the notification management component as described herein. Process 300 may be performed by a processing logic that may comprise hardware (e.g., circuitry, dedicated logic, programmable logic, microcode, etc.), software (e.g., instructions run on a processing device), or a combination thereof. In one embodiment, the notification management component executes the method 300 to process notifications in accordance with a notification rule associated with one or more data fields of a business listing associated with a merchant system.

According to embodiments, at operation 310, the processing logic tracks activity associated with updating one or more data fields of a business listing associated with a merchant system. In an embodiment, the activity may relate to the updating of one or more data fields by multiple different merchant systems in a same industry as a first merchant system (e.g., a group of competitors associated with the merchant). For example, the processing logic may monitor multiple merchant systems in a cluster or group (e.g., merchants in a same industry, field or sector can be grouped to define a merchant group or class). The updating activity of the merchant group can be monitored by the notification management component.

According to embodiments, the activity may include historical data relating to the updating of one or more data fields by the merchant system. Previous updating activity performed by the merchant system can be tracked and measured to determine a pattern, trend, or frequency of the updating of a data field by the merchant system. For example, a merchant system may update of a ‘holiday hours’ field every November for the past four years. In this example, the processing logic tracks this activity for use in the generation of a corresponding notification rule, as described in detail below.

According to embodiments, at operation 320, the processing logic generates, based on the activity, a rule associated with the one or more data fields of the business listing of the merchant system, wherein the rule includes a time parameter and an identification of a first data field of the business listing. In an embodiment, as described above with respect to operation 210 of process 200, the rule can indicate a time parameter (e.g., a time frame and frequency) for the transmission of the notification (nudge) to the merchant system to update an identified data field. In an example, the identified data field may be a data field that is updated frequently (e.g., above a threshold value associated with an updating frequency) by other merchant systems in an associated merchant group, as determined based on the tracked activity. In another example, based on the tracking of the merchant system activity in operation 310, the identified data field may be updated according to a pattern by the merchant system (e.g., the holiday hours field may be updated every November) and the notification rule can be formulated to send a notification to the merchant system on November 1^{st} every year to update the holiday hours field.

According to embodiments, at operation 330, the processing logic executes the rule to monitor the merchant system for an update to the first data field of the business listing (e.g., the data field identified by the rule). In an embodiment, if the processing logic determines, based on the monitoring, that the first data field has been updated by the merchant system then the processing logic determines that a notification is not needed at the present time. In an embodiment, the processing logic may store information about the update in a record associated with the rule. In an embodiment, the processing logic can monitor the merchant system and determine that an update has not been made to the first data field during a time frame (e.g., within the last day, within the last week, within the last year, etc.)

According to embodiments, at operation 340, the processing logic transmits a notification to the merchant system, wherein the notification includes a prompt to update a value stored in the first data field of the business listing. In an embodiment, the notification can be transmitted according to any suitable communication platform or protocol. In an embodiment, the rule can indicate one or more particular merchant users to send the notification. Examples of a notification and prompt to update the first field are shown in FIG. 6. In one example, the exchange 600 includes a notification (e.g., Message 1) from the notification management component (NMC) identifying the first data field 610 and corresponding time parameter 620. In this example, Message 2 is a prompt to the merchant system to update the first data field 610. In the example exchange 630 in FIG. 6, a notification (e.g., Message 1) from the notification management component identifies the first data field 640.

According to embodiments, at operation 350, the processing logic receives a response from the merchant system comprising an updated value corresponding to the first data field of the business listing. In some embodiments, the response is received by the knowledge management system 100 via any suitable communications platform or protocol (e.g., SMS message, e-mail, post, chat, etc.). For example, in the exchange 600 shown in FIG. 6, a response (e.g., Message 3a) can be received from the merchant system (e.g., the merchant user) indicating a desire to update the first data field 610. Similarly, in the exchange 630 shown in FIG. 6, a response (e.g., Message 2a) can be received from the merchant system (e.g., the merchant user) indicating a desire to update the first data field 640. In response, the processing logic executes a process to receive the updated value for the first data field (e.g., as noted by the “ . . . jump to update [field] process” notation in FIG. 6. In an embodiment, the data field update process can include the continuation of the exchange (e.g., exchange 600 or exchange 630) to receive the updated value for the first data field. In another embodiment, the data field update process can include providing access to a portal or interface associated with the business listing wherein the merchant user can input, enter, or select the updated value for the first data field.

According to embodiments, at operation 350, the processing logic stores corresponding to the first data field in an updated record associated with the business listing. In an embodiment, the processing logic maintains a record associated with each business listing and updates the stored record with the updated value to produce the updated record.

According to embodiments, at operation 360, the processing logic transmits at least a portion of the updated record to a business listing provider system. In an embodiment, the processing logic can transmit the entire updated record or a portion of the updated record relating to the updated value for the first data field. In an embodiment, the business listing provider system can include the merchant system (e.g., for updating an application or website associated with the merchant system), a search provider (e.g., Google™), a third party website or application (e.g., Yelp™). In an embodiment, following the transmission of the updated record to the business listing provider, a subsequent search query from an end user results in a response including the updated value for the first data field that was stored in response to the notification from the notification management system.

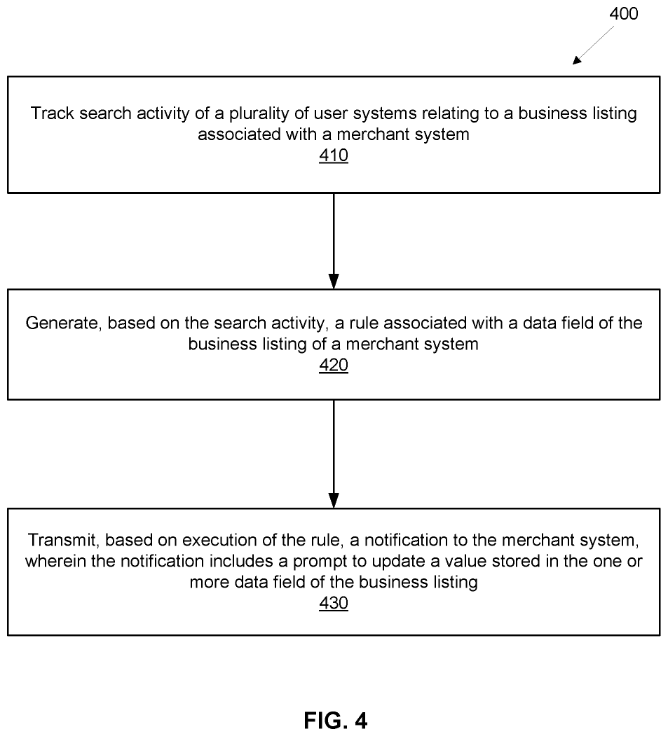

FIG. 4 illustrates a flowchart that provides an example of a process 400 executed by processing logic of a system (e.g., a notification management component 115 of a knowledge management system 100 of FIG. 1), according to various embodiments. It is understood that the flowchart of FIG. 4 provides an example of the many different types of functional arrangements that may be employed to implement the operation of the notification management component as described herein. Process 400 may be performed by a processing logic that may comprise hardware (e.g., circuitry, dedicated logic, programmable logic, microcode, etc.), software (e.g., instructions run on a processing device), or a combination thereof. In one embodiment, the notification management component executes the method 400 to generate notifications in accordance with a notification rule associated with one or more data fields of a business listing associated with a merchant system in view of search query activity associated with the merchant system.

According to embodiments, at operation 410, the processing logic tracks search activity of a plurality of user systems relating to a business listing associated with a merchant system. In an embodiment, the processing logic identifies and tracks information relating to search queries executed by end user systems (e.g., search queries 172 of FIG. 1) relating to business listing data of a merchant system. In an embodiment, the processing logic can identify one or more data fields to target for updating based on the search queries. For example, the processing logic can identify a first data field (e.g., a store phone number data field) that were the subject of the search queries that satisfies a search activity condition. In an embodiment, the search activity associated with the first data field satisfies the search activity condition if the activity meets or exceeds a threshold search level value (e.g., a data field that was the subject of greater than or equal to ten percent (i.e., the threshold search value) of the total searches associated with the merchant system).

According to embodiments, at operation 420, the processing logic generates, based on the search activity, a rule associated with a data field of the business listing of a merchant system. In an embodiment, the rule can identify one or more data fields and a time parameter, identified based on the search activity. In the example above, the store phone number data field is identified as a target data field to serve as the subject of the generated notification rule.

According to embodiments, at operation 430, the processing logic transmits, based on execution of the rule, a notification to the merchant system, wherein the notification includes a prompt to update a value stored in the data field of the business listing. As described in detail above, the update can include correcting, completing, changing, augmenting, or other suitable action with respect to the value of the data field. For example, if the data field has no value (e.g., a restaurant menu), the notification can include a prompt to the merchant system to provide a copy of the menu (e.g., a PDF file) or a link to the menu (e.g., a web-based address to a copy of the menu). It is noted that following execution of operation 430, the process 400 can continue with one or more further operations relating to the management of the notification as described in connection with FIGS. 2 and 3 (e.g., operations 240-260 of FIG. 2 and operations 350-370 of FIG. 3).

FIG. 7 illustrates an example interface 700 associated with management of notifications (or “nudges”) relating to multiple data fields of a business listing data associated with a merchant system, in accordance with one or more aspects of the disclosure. As shown in FIG. 7, an interface 700 or portal can be generated by the knowledge management system to enable interactions with a merchant system to management notifications relating to the business listing data of the merchant. Multiple notification rules can be selected, established, or reviewed via the interface 700. As shown, a rule corresponding to multiple different data fields 710 can be managed via the interface 700, where each rule identifies a data field 710 and a time parameter 720 (e.g., frequency). Interface 700 includes an option to generate a “one-time” notification to create a customized notification and corresponding rule.

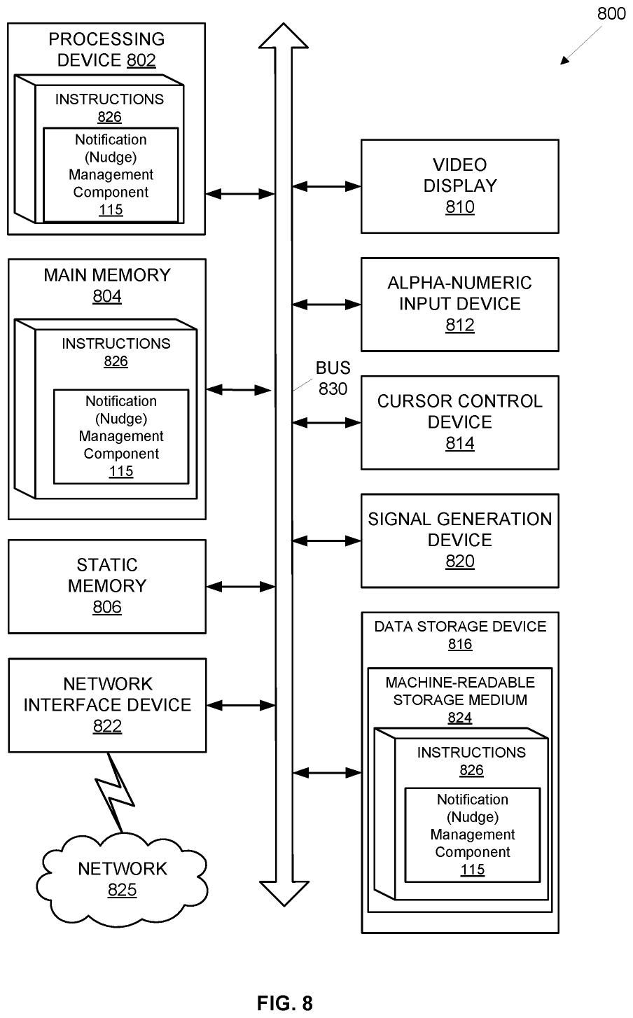

FIG. 8 illustrates an example computer system 800 operating in accordance with some embodiments of the disclosure. In FIG. 8, a diagrammatic representation of a machine is shown in the exemplary form of the computer system 800 within which a set of instructions, for causing the machine to perform any one or more of the methodologies discussed herein, may be executed. In alternative embodiments, the machine 800 may be connected (e.g., networked) to other machines in a local area network (LAN), an intranet, an extranet, or the Internet. The machine 800 may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine 800. Further, while only a single machine is illustrated, the term “machine” shall also be taken to include any collection of machines that individually or jointly execute a set (or multiple sets) of instructions to perform any one or more of the methodologies discussed herein.

The Example computer system 800 may comprise a processing device 802 (also referred to as a processor or CPU), a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.), and a secondary memory (e.g., a data storage device 816), which may communicate with each other via a bus 830.

Processing device 802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. Processing device 802 is configured to execute logic or instructions associated with the notification management component 115 for performing the operations and steps discussed herein. For example, the processing device 802 may be configured to execute instructions implementing method 200, method 300 and 400, for managing notifications to a merchant system relating to one or more data fields of a business listing, in accordance with one or more aspects of the disclosure.

Example computer system 800 may further comprise a network interface device 822 that may be communicatively coupled to a network 825. Example computer system 800 may further comprise a video display 810 (e.g., a liquid crystal display (LCD), a touch screen, or a cathode ray tube (CRT)), an alphanumeric input device 812 (e.g., a keyboard), a cursor control device 814 (e.g., a mouse), and an acoustic signal generation device 820 (e.g., a speaker).

Data storage device 816 may include a computer-readable storage medium (or more specifically a non-transitory computer-readable storage medium) 824 on which is stored one or more sets of executable instructions 826. In accordance with one or more aspects of the present disclosure, executable instructions 826 may comprise executable instructions encoding various functions of the dynamic review optimizer logic 160 in accordance with one or more aspects of the present disclosure.

Executable instructions 826 may also reside, completely or at least partially, within main memory 804 and/or within processing device 802 during execution thereof by example computer system 800, main memory 804 and processing device 802 also constituting computer-readable storage media. Executable instructions 826 may further be transmitted or received over a network via network interface device 822.

While computer-readable storage medium 824 is shown as a single medium, the term “computer-readable storage medium” should be taken to include a single medium or multiple media. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “storing,” “monitoring,” “transmitting,” “receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general-purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method comprising:
storing a rule associated with a data field of a business listing associated with a merchant system;
monitoring, by processing device, the merchant system to determine an occurrence of an event corresponding to the rule;
in response to the occurrence of the event, transmit a notification to the merchant system, wherein the notification includes a prompt to update a value stored in the data field of the business listing;
receiving a response from the merchant system comprising an updated value corresponding to the data field of the business listing;
storing the updated value corresponding to the data field in an updated record associated with the business listing; and
transmitting at least a portion of the updated record to a business listing provider system.

2. The method of claim 1, further comprising:
receiving, from the merchant system, one or more inputs identifying the data field and a time parameter corresponding to the rule; and
generating the rule based on the one or more inputs.

3. The method of claim 1, further comprising generating, by the processing device, the rule, wherein the rule identifies the data field and a time parameter.

4. The method of claim 3, wherein the time parameter comprises a time frame during which at least one of the notification or one or more follow-up notifications are to be transmitted to the merchant system.

5. The method of claim 4, wherein the time parameter comprises a frequency associated with transmitting the notification or the one or more follow-up notifications.

6. The method of claim 1, further comprising generating the rule based at least in part on search query activity associated with the merchant system.

7. The method of claim 1, wherein the event comprises an expiration of a time period associated with updating the data field.

8. A system comprising:
a memory to store instructions; and
a processing device operatively coupled to the memory, the processing device to execute the instructions to:
track activity associated with updating one or more data fields of a business listing associated with a merchant system;
generate, based on the activity, a rule associated with the one or more data fields of the business listing of the merchant system, wherein the rule includes a time parameter and an identification of a first data field;
execute the rule to monitor the merchant system for an update to the first data field of the business listing; and
transmit a notification to the merchant system, wherein the notification includes a prompt to update a value stored in the first data field of the business listing.

9. The system of claim 8, wherein the activity comprises a set of data relating to updates to the data field by a plurality of third party systems in a cluster comprising the merchant system.

10. The system of claim 8, wherein the activity comprises a set of data relating to updates to the data field by the merchant system.

11. The system of claim 8, wherein the notification is transmitted to one or more devices associated with the merchant system.

12. The system of claim 8, the processing device to execute the instructions to:
receive a response from the merchant system comprising an updated value corresponding to the first data field of the business listing; and
store the updated value corresponding to the first data field in an updated record associated with the business listing.

13. The system of claim 12, wherein the updated value comprises at least one of new data to complete the data field, a changed value for data corresponding to the data field, or additional data added to the data field.

14. The system of claim 12, the processing device to execute the instructions to transmit at least a portion of the updated record to a business listing provider system.

15. The system of claim 14, wherein the business listing provider system comprises at least one of a website associated with the merchant system or a third party search engine system.

16. A non-transitory computer readable storage medium having instructions that, if executed by a processing device, cause the processing device to:
track search activity of a plurality of user systems relating to a business listing associated with a merchant system;
generate, based on the search activity, a rule associated with a data field of the business listing of a merchant system; and
transmit, based on execution of the rule, a notification to the merchant system, wherein the notification includes a prompt to update a value stored in the one or more data field of the business listing.

17. The non-transitory computer readable storage medium of claim 16, the processing device further to:
receive a response to the notification from the merchant system comprising an updated value corresponding to the data field of the business listing; and
store the updated value corresponding to the data field in an updated record associated with the business listing.

18. The non-transitory computer readable storage medium of claim 17, the processing device further to transmit the updated record to a business listing provider system.

19. The non-transitory computer readable storage medium of claim 16, wherein the search activity associated with the data field satisfies a search activity condition.

20. The non-transitory computer readable storage medium of claim 19, wherein the search activity condition comprises a first percentage of search activity associated with the data field exceeds a threshold value of a total search activity associated with the business listing.
